(19) United States
(12) Patent Application Publication
(10) Pub. No.: US 2015/0286980 A1
(43) Pub. Date: Oct. 8, 2015

(54) COMMUNICATING ABOUT, ORGANIZING, AND FACILITATING COMPLETION OF TASKS

(71) Applicant: eduDollars, LLC, Pittsburgh, PA (US)

(72) Inventor: Chana M. Shusterman, Pittsburgh, PA (US)

(73) Assignee: eduDollars, LLC, Pittsburgh, PA (US)

(21) Appl. No.: 14/245,408

(22) Filed: Apr. 4, 2014

(51) Int. Cl. G06Q 10/06

(52) U.S. Cl. CPC G06Q 10/063114

(57) ABSTRACT

The present invention provides methods, systems, computer program products, and apparatuses for communicating about, organizing, and facilitating completion of tasks. In one embodiment, a system comprising one or more memory storage areas and one or more processors is provided. The system may store information associated with tasks to be completed, such as a work value associated with each task. The system may store information associated with a plurality of user profiles. Two or more user profiles may be linked to create a group profile. The system may also receive input associated with the first user profile and indicating hours worked by the user to assist with completion of a task; associate a work value with the received input based on the work value associated with the task and/or the hours worked by the user; and store said work value in association with the first user profile and the group profile.

### TECHNOLOGICAL FIELD

Embodiments of the present invention are generally related to communicating about, organizing, and facilitating the completion of jobs/tasks by volunteers or other individuals.

### BACKGROUND

Volunteer and other organizations generally maintain databases or other data stores of volunteers and/or other individuals associated with the organizations. Information maintained in these databases, for instance, may be used to send correspondence to volunteers and/or other individuals providing information regarding volunteer opportunities and/or opportunities to assist with the completion of various jobs/tasks. The correspondence may ask volunteers and/or other individuals to call the organization to sign up to assist with the completion of various jobs/tasks, or the correspondence may be an email with a link to a Google Drive document where volunteers and/or other individuals can sign up to assist with the completion of various jobs/tasks. However, a Google Drive document may allow a volunteer to sign up herself and her three friends without the consent of her friends. The friends may or may not show up to help complete the job/task. This method of organizing and facilitating completion of jobs/tasks also makes it difficult for organizations to track the hours worked by a particular individual and the total number of hours worked by volunteers and/or other individuals.

Therefore, a need exists for improved methods, apparatus, systems, computer program products, computing devices, computing entities, and/or the like for organizing and facilitating completion of jobs/tasks.

### BRIEF SUMMARY

In general, embodiments of the present invention provide methods, apparatus, systems, computer program products, computing devices, computing entities, and/or the like for communicating about, organizing, and facilitating completion of various jobs/tasks. The various jobs/tasks may be associated with an organization, municipality or other government entity, non-profit, not-for-profit, business, school, group, family and/or the like. In various embodiments, methods, systems, computer program product, and apparatuses are provided.

According to one aspect of the present invention, a system for communicating about, organizing, and facilitating completion of tasks is provided. The system may comprise one or more memory storage areas and one or more processors. The system may be configured to store information associated with one or more tasks to be completed. The information associated with the one or more tasks to be completed may comprise a work value associated with each of the one or more tasks. The system may also be configured to store information associated with a plurality of user profiles. Each user profile may be associated with a user. At least a first user profile and a second user profile may be linked to create a group profile. The system may be further configured to receive input associated with the first user profile and indicating hours worked by a user associated with the first user profile to assist with completion of one of the one or more tasks; associate a work value with the received input based at least in part on at least one of the work value associated with the one of the one or more tasks and the hours worked by the user to assist with completion of the one of the one or more tasks; and store the work value and/or a calculated balance owed in association with the first user profile and the group profile.

In another aspect of the present invention, a method for organizing and facilitating completion of tasks is provided. The method may comprise storing information associated with one or more tasks to be completed. The information associated with the one or more tasks to be completed may comprise a work value associated with each of the one or more tasks. The method may also comprise storing information associated with a plurality of user profiles. Each user profile may be associated with a user. At least a first user profile and a second user profile may be linked to create a group profile. The method may further comprise receiving input associated with the first user profile and indicating hours worked by a user associated with the first user profile to assist with completion of one of the one or more tasks; associating a work value with the received input based at least in part on at least one of the work value associated with the one of the one or more tasks and the hours worked by the user to assist with completion of the one of the one or more tasks; and storing the work value in association with the first user profile and the group profile.

In yet another aspect, a computer program product for organizing and facilitating completion of tasks is provided. The computer program product comprises at least one non-transitory computer-readable storage medium having computer-readable program code portions stored therein. The computer-readable program code portions may comprise an executable portion configured for receiving and storing a plurality of data, the plurality of data comprising: information associated with one or more tasks to be completed, and information associated with a plurality of user profiles. The information associated with the one or more tasks to be completed may comprise a work value associated with each of the one or more tasks. Each user profile may be associated with a user. At least a first user profile and a second user profile may be linked to create a group profile. The computer-readable program code portions may further comprise an executable portion configured to receive input associated with the first user profile and indicating hours worked by a user associated with the first user profile to assist with completion of one of the one or more tasks; an executable portion configured to associate a work value with the received input based at least in part on at least one of the work value associated with the one of the one or more tasks and the hours worked by the user to assist with completion of the one of the one or more tasks; and an executable portion configured to store said work value in association with the first user profile and the group profile.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of a system for organizing and facilitating completion of various jobs/tasks, in accordance with one embodiment the present invention;

FIG. 2 is a schematic diagram of an organizing system, in accordance with one embodiment of the present invention;

FIG. 3 is a flowchart illustrating processes and operations related to organizing and facilitating completion of jobs/tasks, in accordance with one embodiment of the present invention;

FIG. 4 illustrates an example user profile, in accordance with an embodiment of the present invention;

FIGS. 5-20 illustrate various views and/or partial views of an example interactive user interface, in accordance with an embodiment of the present invention.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. METHODS, APPARATUS, SYSTEMS, AND COMPUTER PROGRAM PRODUCTS

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like. In some embodiments, the non-volatile storage medium may be accessed remotely (e.g., via “the cloud”).

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. GENERAL OVERVIEW

Embodiments of the present invention provide methods, apparatus, systems, computer program products, computing devices, computing entities, and/or the like for communicating about, organizing, and facilitating completion of jobs/tasks. The disclosure provided herein presents the example of communicating about, organizing, and facilitating completion of jobs/tasks associated with a school. As should be understood, the following disclosure may also relate to organizing and facilitating completion of jobs/tasks related to a volunteer organization, municipality or other government organization, business, family unit, and/or the like. For example, embodiments of the present invention may be used to communicate about, organize, and facilitate volunteer opportunities, customer loyalty programs, achievement programs, tracking of group accomplishments and achievement toward goals, child allowance programs, combinations thereof, and/or the like. In one example embodiment, a company may organize and facilitate various volunteer activities related to a philanthropic priority for the company and provide incentives for customers to participate in the volunteer activities. In another embodiment, a group similar to the boy scouts, girl scouts, or a camp may use a program similar to that disclosed herein to facilitate tracking of achievement of tasks and/or skills, points, levels, awards, completion of tasks or learning of skills toward achieving a badge, award, rank, and/or the like.

In various embodiments, one or more job/task listings may be created by an administrator or other user having permission to create jobs/tasks. A user may view the available jobs/tasks and sign up to assist with completing one or more available jobs/tasks. After at least partial completion of a job/task, the user may report the hours the user worked related to the at least partial completion of the job/task. The hours worked may be stored in association with a user profile associated with the user. In various embodiments, a work value may be assigned to a job/task or to each hour spent working toward completion of a job/task. When a user reports the hours worked in relation to at least the partial completion of a job/task, the work value achieved for those hours may be determined and stored in association with the user profile. A goal work value or target achieved work value may also be associated with the user profile. A user may be provided with information comparing the achieved work value and the goal work value associated with the user profile. In various embodiments, two or more user profiles may be linked to each other to create a family or group profile.

Various system architectures that may be used in accordance with the present invention will now be described herein.

### III. EXEMPLARY SYSTEM ARCHITECTURE

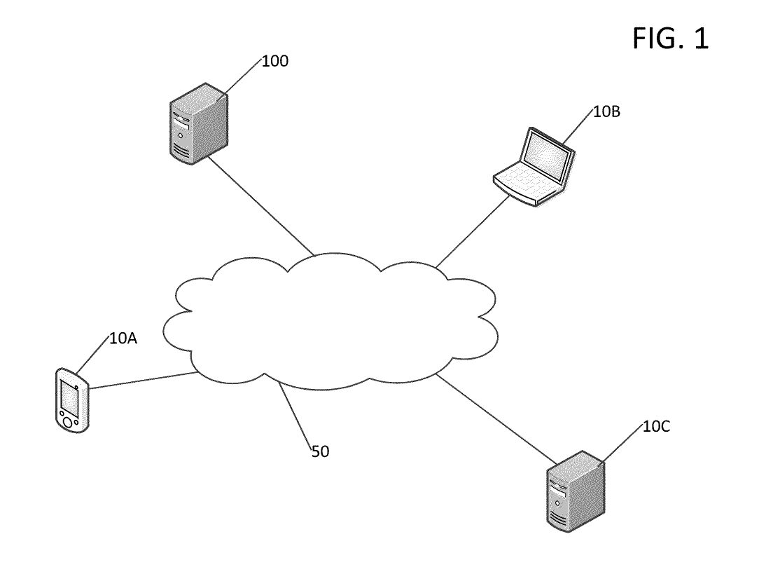

FIG. 1 illustrates one embodiment of a system that may implement the present invention. In this particular embodiment, the illustrated system may include one or more organizing systems 100 and one or more user computing entities 10A, 10B, 10C. The one or more organizing systems 100 and the one or more user computing entities 10A, 10B, 10C may communicate with each other and/or a variety of other computing entities via one or more wired or wireless networks, such as network 50. An example organizing system 100 and example user computing entities 10A, 10B, 10C will now be described.

### Organizing System 100

The organizing system 100 may be operated by or on behalf of an organization, municipality or other government entity, business, non-profit, not-for-profit, troop, family, and/or the like. For example, in the example provided below, the organizing system 100 is operated by or on behalf of a school. In various embodiments, the organizing system 100 may be configured to provide one or more users with an interactive user interface configured for organizing and facilitating completion of one or more jobs/tasks.

In general, the terms computing entity, network, network entity, entity, device, system, and/or similar words used herein interchangeably may refer to, for example, one or more computers, computing entities, computing devices, mobile phones, smartphones (e.g., iPhone, Android, and/or the like), gaming consoles (e.g., Xbox, Play Station, Wii), desktops, tablets, notebooks, laptops, distributed systems, servers or server networks, blades, gateways, switches, processing devices, processing entities, relays, routers, distribution systems, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

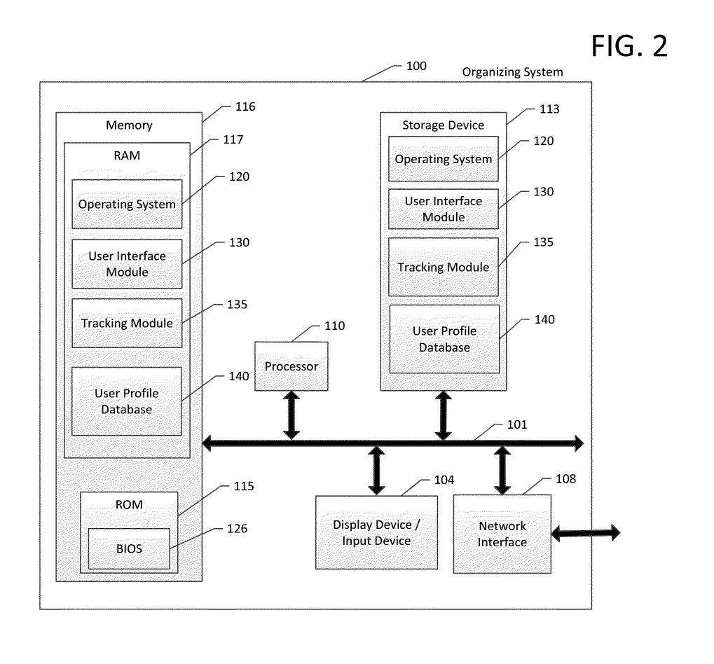

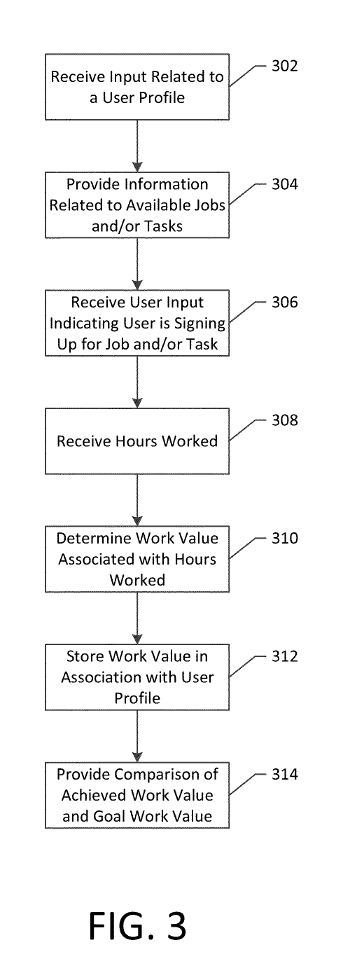

FIG. 2 provides a schematic diagram of an example organizing system 100. The organizing system 100 comprises a processor 110, such as one or more processing elements, which may include complex programmable logic devices (CPLDs), microprocessors, multi-core processors, coprocessing entities, application-specific instruction-set processors (ASIPs), and/or controllers or other processing devices or circuitry. The term circuitry may refer to an entirely hardware embodiment or a combination of hardware and computer program products. Thus, the processor 110 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 110 may be configured for a particular use or configured to execute instructions stored in volatile or non-volatile media or otherwise accessible to the processor 110. As such, whether configured by hardware or computer program products, or by a combination thereof, the processor 110 may be capable of performing steps or operations according to embodiments of the present invention, such as the embodiment illustrated in FIG. 3, when configured accordingly. The processor 110 is used to execute software instructions for carrying out the defined steps of the method of the various embodiments of the present invention. The processor 110 communicates using a data bus 101 that is used to convey data and program instructions, typically, between the processor and memory 116.

The organizing system 100 further includes memory 116, which may comprise non-volatile media (also referred to as non-volatile storage, memory, memory storage, memory circuitry and/or similar terms used herein interchangeably). In one embodiment, the non-volatile storage or memory may include one or more non-volatile storage or memory media as described above, such as hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include the user interface module 130, and/or tracking module 135. The terms database, database instance, database management system, and/or similar terms used herein interchangeably may refer to a structured collection of records or data that is stored in a computer-readable storage medium, such as via a relational database, hierarchical database, and/or network database. Such databases may include a user profile database 140.

In at least one embodiment, the organizing system 100 may further include or be in communication with volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor 110. Thus, the databases, database instances, database management systems, data, applications, programs, program modules, scripts, source code, object code, byte code, compiled code, interpreted code, machine code, executable instructions, and/or the like may be used to control certain aspects of the operation of the organizing system 100 with the assistance of the processor 110 and operating system 120, user interface module 130, and/or tracking module 135.

As indicated, a number of program modules may be stored by the non-volatile and/or volatile memory. Such program modules may include the user interface module 130 and/or tracking module 135. Those skilled in the art will appreciate that other modules may be present in RAM 117 to effectuate various embodiments of the present invention. Furthermore, in addition to the described modules, other modules may be used or embodiments may not be modular.

As indicated, in one embodiment, the organizing system 100 may also include one or more communications interfaces 108 for communicating with various computing entities, such as by communicating data, content, information, and/or similar terms used herein interchangeably that can be transmitted, received, operated on, processed, displayed, stored, and/or the like. For instance, the organizing system 100 may be in communication with one or more user computing entities 10A, 10B, 10C via various wired or wireless network 50. Such communication may be executed using a wired data transmission protocol, such as fiber distributed data interface (FDDI), digital subscriber line (DSL), Ethernet, asynchronous transfer mode (ATM), frame relay, DOCSIS, Programming Metadata Communication Protocol (PMCP), or any other wired transmission protocol. Similarly, the organizing system 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, any other wireless protocol, and/or any other appropriate communications protocol. In various embodiments, the organizing system 100 may be configured to communicate with various computing entities to organize and facilitate completion of one or more jobs/tasks.

Various information can be input by a user (e.g., operating a user computing device 10 or other appropriate computing entity) to the organizing system 100 via the network interface 108 and/or input/output device 104. This input information may include information related to a job/task, information related to a user signing up for a job/task, information related to hours worked in relation to at least the partial completion of a job/task, or other information. This input information may vary, however, depending on the configuration and informational requirements of the organizing system 100.

As mentioned above, the organizing system 100 also includes an input/output device 104 for receiving and displaying data. The organizing system 100 may include or be in communication with one or more input elements, such as a keyboard input, a mouse input, a touch screen/display input, audio input, pointing device input, joystick input, keypad input, and/or the like, as indicated by input/output device 104. The organizing system 100 may also include or be in communication with one or more output elements, as indicated by input/output device 104, such as audio output, video output, screen/display output, motion output, movement output, and/or the like.

The organizing system 100 may be configured to facilitate creation of one or more job/task listings, create and/or update one or more user profiles, receive and store input related to a user signing up to assist with completion of a job/task, and/or the like via, for example, the user interface module 130. The organizing system 100 may further be configured to receive and store input related to hours worked in relation to at least the partial completion of a job/task, determine and store information related to an achieved work value (e.g., a work value associated with work completed and reported by the user) associated with a user profile, provide information comparing the achieved work value to a goal work value (e.g., the goal amount of work value that the user is trying to accrue in a given time period) associated with a user profile, and/or the like via, for example, the tracking module 135. In various embodiments, the organizing system 100 may be configured to provide a user with an interactive user interface via a website, local program, mobile application, and application programming interface (API) enabled program configured to plug-in to an existing website or program. The organizing system 100 may be further configured to complete other tasks related to the organizing and facilitating of one or more jobs/tasks.

Those skilled in the art will recognize that many other alternatives and architectures are possible and can be used to practice various embodiments of the invention. The embodiment illustrated in FIG. 2 can be modified in different ways or incorporated within a network and be within the scope of the invention. For example, one or more components of the organizing system 100 may be located remotely from other organizing system 100 components, such as in a distributed system. Furthermore, one or more of the components may be combined and additional components performing functions described herein may be included in the organizing system 100. Thus, the organizing system 100 can be adapted to accommodate a variety of needs and circumstances.

### User Computing Entity 10

In various embodiments, the user computing entity 10 (e.g., 10A, 10B, 10C) may be configured to communicate with the organizing system 100 in order to organize and facilitate completion of one or more jobs/tasks. The user computing entity 10 is any system used by or on behalf of a user to facilitate and/or track the user's participation in the completion of one or more jobs/tasks. For example, as described above, a user computing entity 10 may be one or more computers, mobile phones, smartphone (e.g., iPhone, Android, and/or the like), gaming consoles (e.g., Xbox, Play Station, Wii), desktops, tablets, notebooks, phablets, set-top devices in communication with a television or other display device (e.g., projector or the like), smart televisions, laptops, wearable computer, and/or any combination of devices or entities adapted to perform the functions, operations, and/or processes described herein. In one embodiment, the user computing entity 10 may comprise a combination of two or more computing devices noted above and/or other computing devices.

In one embodiment, the user computing entity 10 may include one or more components that are functionally similar to those of the organizing system 100. In one embodiment, the user computing entity 10 may include one or more processing elements, one or more display device/input devices, volatile and non-volatile storage or memory, and/or one or more communications interfaces. The user computing entity 10 may also comprise various other systems. In particular, the user computing entity 10 may include components configured to display information related to one or more jobs/tasks, receive input indicating a user would like to assist with completion of one or more jobs/tasks, receive input comprising the number of hours worked in relation to at least the partial completion of one or more jobs/tasks, displaying information comparing the achieved work value and the goal work value associated with a user profile associated with the user, and/or the like. The user computing entity 10 may also be in communication with a variety of computing entities.

In various embodiments, the user computing entity 10 may include or otherwise be in communication with a variety of input devices that may be configured to receive input from a user such that a user may control his/her experience of the user interface. For example, in some embodiments, the user computing entity 10 may include or be in communication with a pointing device such as a computer mouse, infrared pointing device, motion detecting device, and/or the like. In other embodiments, the user computing entity 10 may include or be in communication with a joy stick, remote control, handheld controller which may include a d-pad, and/or the like. Thus, the user computing entity 10 may be configured to receive user input through a variety of input approaches and techniques.

### IV. EXEMPLARY SYSTEM OPERATION

As noted above, the system operation will be described herein with reference to a parent volunteer program at a school. It should be understood that the concepts discussed herein may be utilized in various other settings. For example, the concepts may be utilized in a city volunteer program or a program in which a company encourages customers to participate in a particular philanthropic pursuit by offering goals and rewards for customer participation. Moreover, the following describes a user's (e.g., operating a user computing entity 10A, 10B, 10C) interaction with the organizing computing entity 100.

FIG. 3 provides a general overview of some of the processes and functions that may be completed in relation to organizing and facilitating a parent volunteer program at a school, in accordance with various embodiments of the present invention. A user may access the user interface via a dedicated window, a dedicated application, a mobile app (e.g., a native mobile application), Firefox, Internet Explorer, Chrome, other Web browser, and/or the like operating on a user computing entity 10. At step 302, the user provides input related to a user profile (e.g., via the user computing entity 10). For example, the user may access the user interface and enter a user name and password or the user may sign up for an account and enter information for a user profile.

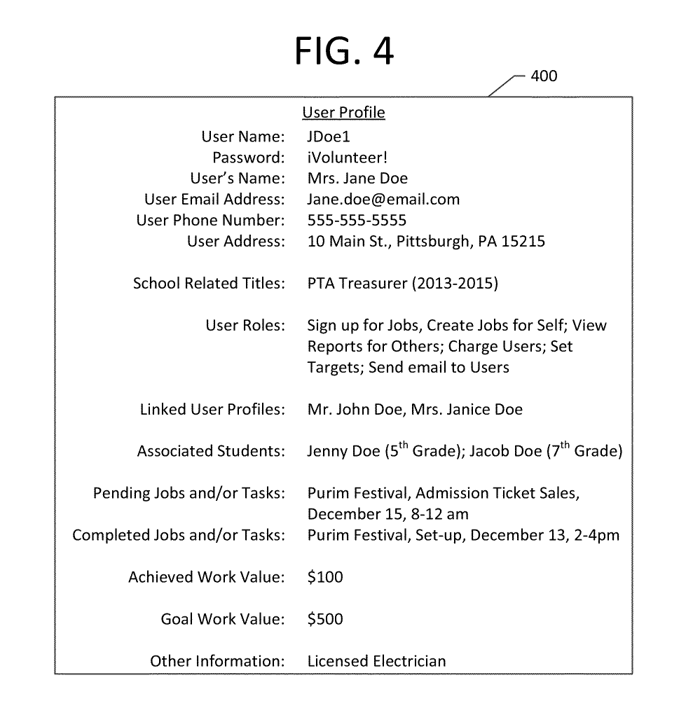

FIG. 4 provides an example user profile 400, according to an embodiment of the present invention. In various embodiments, the user profile 400 may be stored in a user profile database 140 associated with the organizing system 100, and/or the like. As illustrated, the user profile 400 may be associated with a user name and password that the user may use to access the parent volunteer program via the user interface (e.g., operating on the user computing entity 10 or the organizing system 100). The user profile 400 may also be associated with the user's name and contact information (e.g., email address; home, work, and/or cell phone number; mailing address; home address; employer; employer address; and/or the like). The user profile 400 may further include a description of the user's relationship with the school. For example, the illustrated user profile 400 is associated with a user who is the Parent Teacher Association (PTA) treasurer from 2013-2015. Other user profiles may indicate that the user is a parent, a community volunteer, the girls' basketball team coach, a parent and a history teacher at the school, a PTA member, a school administrator, and/or the like. As will be discussed in more detail below, a user profile may be assigned various roles, allowed various levels of access, and/or provided with various privileges. The assigned roles and/or provided privileges may be modified at any time by a user associated with a user profile associated with the appropriate administrative roles and/or privileges to change the roles and/or privileges associated with another user's user profile. For example, illustrated user profile 400 is associated with the roles and/or privileges of signing up for jobs/tasks; creating jobs/tasks for self; viewing reports for others; charging users; setting targets; and sending email to users. These various roles and/or privileges will be described in more detail below.

In various embodiments, two or more user profiles 400 may be linked to create a family profile or other group profile. In various embodiments, two or more user profiles 400 may be linked in order to track work value achieved by family members, setting of family work value goals, and comparing work value achieved by family members against the family work value goals. For example, the illustrated user profile for Mrs. Jane Doe is linked to her husband's profile, Mr. John Doe, and her mother-in-law's profile, Mrs. Janice Doe. Therefore, work value achieved by Mrs. Jane Doe, her husband, and her mother-in-law may be combined to reach the family work value goal. A work value may be a value assigned to a certain amount of work. For example, as described in more detail below, at least partial completion of a job/task may be assigned a work value and/or each hour spent working toward at least partially completing a job/task may be assigned a work value. The work value associated with jobs/tasks at least partially completed by a user are referred to herein as an achieved work value. For example, if a user works three hours toward at least the partial completion of a job/task assigned a work value of 10 points per hour, the user will have achieved a work value of 30 points. An example family work value goal may be for the members of the family to collectively achieve 1000 points worth of work value during a semester or a school year.

In various embodiments, the user profile 400 may include the names of and/or other information related to associated students. For example, Mrs. Jane Doe is the mother of fifth grader Jenny Doe and seventh grader Jacob Doe. The user profile 400 may include other information related to associated students. For example, the user profile 400 may include that Jenny Doe is in Mrs. Shusterman's class, is allergic to penicillin, is on one of the girls' soccer team, is in the honors program, and/or the like. The user profile 400 may be further associated with jobs/tasks associated with the user. For example, the illustrated user profile 400 is associated with pending jobs/tasks that the user has signed up for but has not yet completed and jobs/tasks that the user has completed or at least partially completed. The user profile 400 may also be associated with the user and/or family's achieved work value and the user and/or family work value goal.

The user profile 400 may include other information related to the user. In various embodiments, the user profile 400 may include skills, interests, hobbies, and/or the like related to the user. For example, as shown in the illustrated user profile 400, Mrs. Jane Doe is a licensed electrician. Therefore, if the school has a need for a licensed electrician, that may be an opportunity for Mrs. Jane Doe to volunteer her expertise. As will be discussed in more detail below, in some embodiments, in order to sign up for various jobs/tasks, authorization must be provided by one or more appropriate parties. The authorization may be automatic or manual. For example, a listed job/task may require a specific skill set (e.g., a skilled electrician). For such jobs/tasks, a user (e.g., operating a user computing entity 10 (e.g., 10A, 10B, 10C) may provisionally sign up for the job/task that requires a specific skill set, but may need to be authorized to complete the job/task. In one embodiment, since Mrs. Jane Doe's profile indicates that she is a licensed electrician, she may be automatically authorized by the organizing system 100 to complete the job/task. In another embodiment, a user whose user profile is associated with appropriate administrative roles and/or privileges may view Mrs. Jane Doe's profile (e.g., via a user computing device 10 (e.g., 10A, 10B, 10C)) and see that she is a licensed electrician and manually authorize her to complete the job/task. As should be understood, in various embodiments, a user profile may include more or less information than that described herein with respect to user profile 400, and in general, may include the information deemed necessary by the administrator of that particular volunteer program.

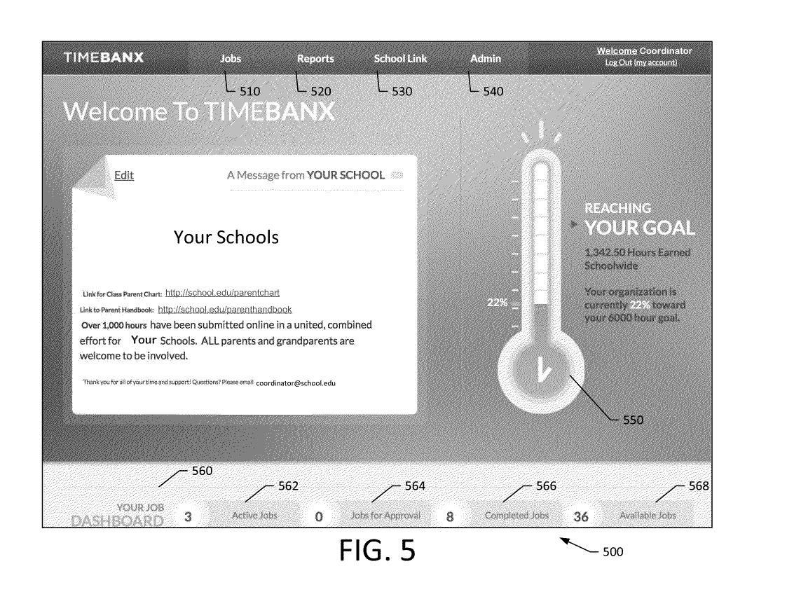

After a user (e.g., operating a user computing entity 10 (e.g., 10A, 10B, 10C)) has provided appropriate log in information and/or signed up for an account and provided user profile information (e.g., via the user computing entity 10), the user (e.g., operating a user computing entity 10 (e.g., 10A, 10B, 10C)) may be directed to a welcome page by the organizing system 100 such as the example welcome page 500 shown in FIG. 5. The welcome page 500 may include a jobs/tasks tab 510, a reports tab 520, an admin tab 530, and a links tab 540. The welcome page 500 may also include organization goal information 550. For example, the illustrated motivational thermometer visually displays the organization's work value achievement in comparison to the organization's work value goal. The welcome page 500 may also include a job/task dashboard 560. The job/task dashboard 560 may include information and/or links to information related to active jobs/tasks 562 that the user has signed up to assist in the completion of, but have not yet been completed, jobs/tasks pending approval 564 that the user has signed up for but are pending approval before they may be completed, completed jobs/tasks 566 that the user has signed up for and assisted in the completion of, and available jobs/tasks 568 that the user may sign up to assist in the completion thereof.

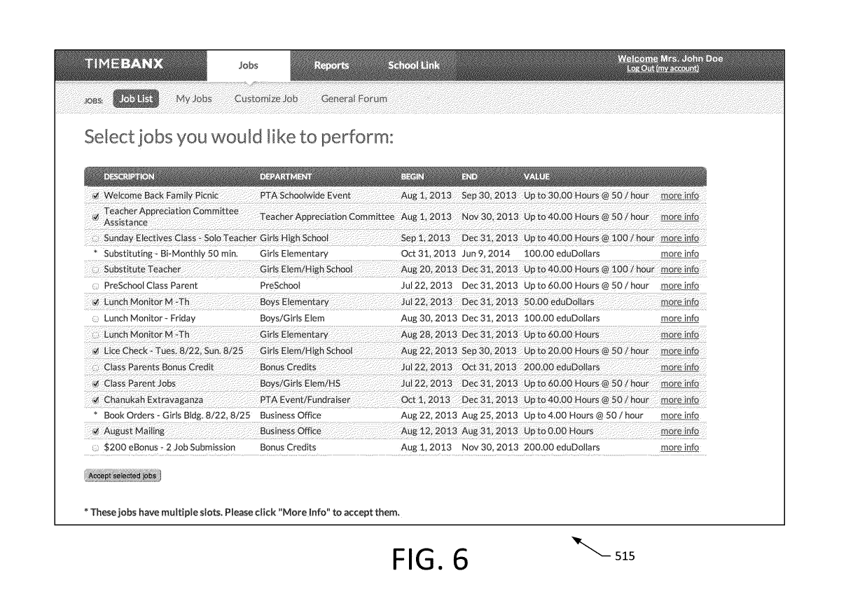

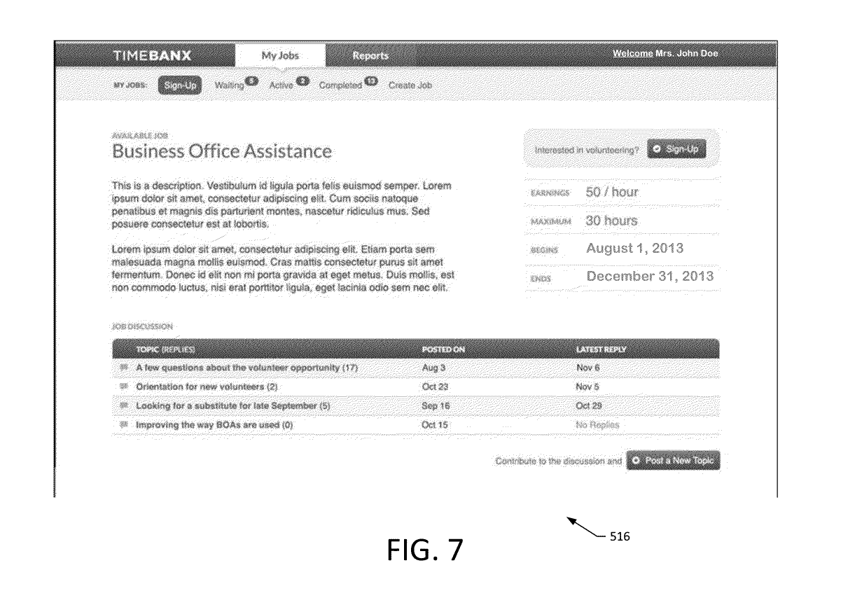

Returning to FIG. 3, the organizing system 100 may provide the user (e.g., operating a user computing entity 10 (e.g., 10A, 10B, 10C) with information related to one or more available jobs and/or tasks. For example, in various embodiments, the user may select the available jobs/task link 568 associated with the job/task dashboard 560 or select via jobs/task tab 510 the available jobs/task sub-tab (e.g., via a user computing entity 10 (e.g., 10A, 10B, 10C)). After the user has selected the available jobs/tasks sub-tab or available jobs/tasks link 568, or perhaps in response thereto, the organizing system 100 may provide the user with an available jobs/tasks page. For example, the user computing entity 10 (e.g., 10A, 10B, 10C) may display the available jobs/task page. FIG. 6 shows an example screen shot of an available jobs/tasks page 515. The page shows a list of available jobs/tasks and presents some information related to the available jobs/tasks. For example, the list of available jobs/tasks may provide a user with a brief job description or title, the department associated with the job/task, a beginning and/or ending date and/or time, an associated work value, and/or the like. Additional information about each job/task may be available via a “more info” link. For example, when a user selects the more info link for a job/task titled “Business Office Assistance,” the organizing system 100 may provide the user (e.g., operating a user computing entity 10 (e.g., 10A, 10B, 10C) a more info page 516 similar to that shown by FIG. 7.

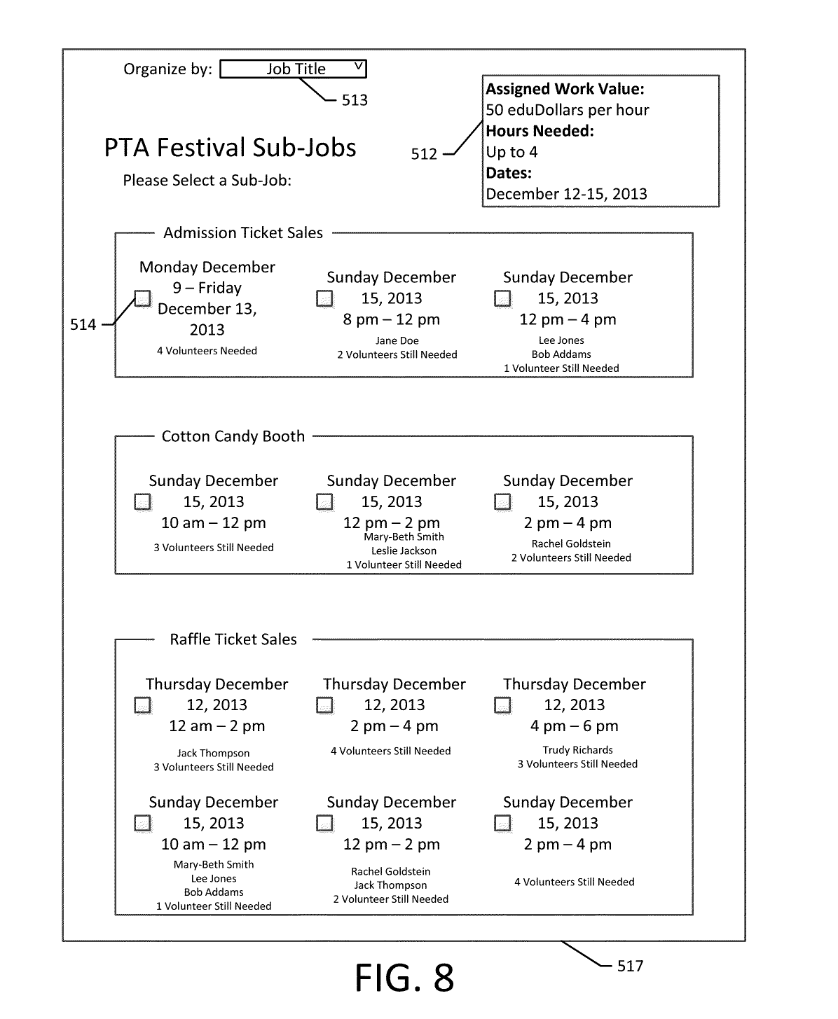

As noted in FIG. 6, some jobs/tasks are associated with multiple times and/or dates. For example, a job/task may have multiple sub-jobs/tasks. FIG. 8 illustrates a multiple sub-job/task info page 517 for the job/task titled “PTA Festival.” For example, a job/task information box 512 indicates information relative to all of the sub-jobs/tasks of the PTA Festival job/task. For example, sub-jobs/tasks of the PTA Festival job/task are assigned a work value of 50 eduDollars per hour, wherein an eduDollar is a virtual currency that may be used to pay a debt to the school, reach a virtual goal, reach an individual and/or group goal, and/or the like. A user may sign up for up to a configurable number of hours (e.g., four hours) of sub-jobs/tasks related to the PTA Festival. The illustrated PTA Festival job/task runs from Thursday December 12 through Sunday Dec. 15, 2013. Additional information may be provided for each sub-job/task. For example, the number of volunteers needed for a sub-job/task, the number and/or name of users already signed up for a sub-job/task, the date and time associated with a sub-job/task, and/or the like, may be provided via the job/task info page 517.

In various embodiments, such as that illustrated in FIG. 8, a drop down menu 513 may be provided so that a user may choose how to organize the available sub-jobs/tasks. For example, a user may choose to organize available sub-jobs/tasks in alphabetical order by job/task title, in date order by date associated with the sub-job/task, by the department associated with the sub-job/task, by the skill set required to complete the sub-hob/task, the time range of the sub-job/task, and/or the like. For example, if a user is generally available between 6:00 and 8:00 pm, the user may select (e.g., via the user computing device 10 (e.g., 10A, 10B, 10C)) via drop down menu 513 to organize the available jobs/tasks by time range or time slot associated with the sub-job/task. In this way, the user may view all sub-jobs/tasks available between 6:00 and 8:00 pm. In other embodiments, other mechanisms may be used for a user to select the organization of the available sub-jobs/tasks. In another example, a user may view the sub-jobs/tasks organized by the number of volunteers still needed for a sub-job/task, the names of users who have already signed up for the sub-jobs/tasks, and/or the like. In yet other embodiments, the user may not be able to choose how the available sub-jobs/tasks are organized. In various embodiments, similar organizing features may be available for the available jobs/tasks page 515.

In various embodiments, a job/task may be removed from and/or otherwise not shown on the available jobs/tasks list after an expiration date associated with the job/task. In some embodiments, the expiration date associated with a job/task may be the end date of the job/task. In various embodiments, a job/task may be removed from and/or otherwise not shown on the available jobs/tasks list after the requested number of users sign up for the job/task. For example, if a job/task requires five users to volunteer, after the fifth user has signed up for the job/task, the job/task may be removed from the list of available jobs/tasks. If one of the users who signed up for the job/task has something come up where they cannot assist with the at least partial completion of the job/task, the user may un-sign up to volunteer for the job/task. If the expiration date for the job/task has not passed, the job/task may again be listed on the available job/task list until the volunteer position is filled. A job/task that is removed from the available jobs/tasks page will remain visible on the my jobs/tasks sub-tab for users signed up to assist with the at least partial completion of the job/task.

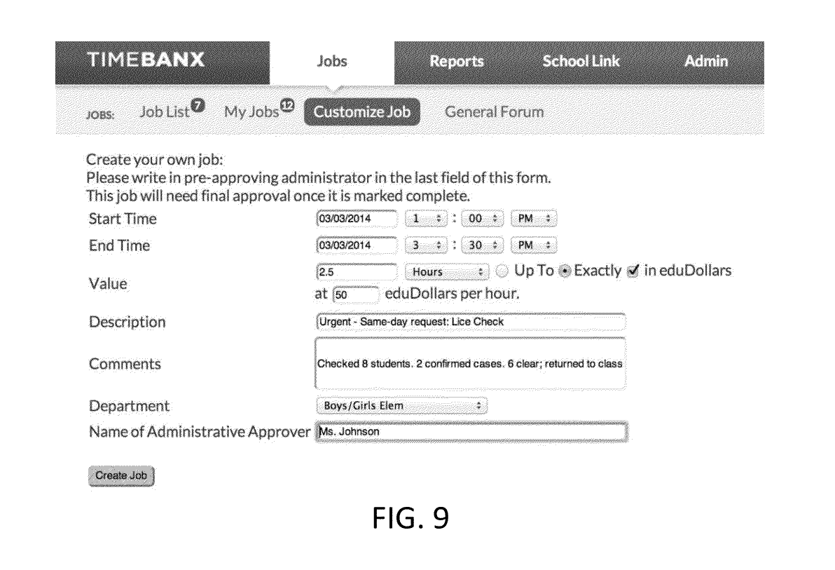

In various embodiments, a user may select the customize job sub-tab illustrated in FIG. 6, and/or the like, to create a customized job/task, as illustrated in FIG. 9. In various embodiments, a user may create a customized job/task independent of the roles and/or privileges associated with the user's user profile. In some embodiments, the customized job/task may be subject to approval by a user having appropriate roles and/or privileges associated with his or her user profile. Indeed, when the user creates the customized job/task, the user may be asked to provide the name and/or title of the administrator or other user having appropriate roles and/or privileges associated with his or her user profile who should approve or who has pre-approved the customized job/task.

Returning to FIG. 3, at step 306, the organizing system 100 receives input indicating a user (e.g., operating a user computing entity 10 (e.g., 10A, 10B, 10C)) would like to assist in completion of a (sub-)job/tasks. For example, in the embodiment illustrated in FIG. 8, the user may sign up to assist with the completion of a sub-job/task by selecting button 514 associated with the sub-job/task the user would like to assist with the completion of. In the embodiment illustrated in FIG. 6, a user may select a job/task (e.g., check a box next to a job/task description) and then select the “Accept Selected Jobs” button. After, or perhaps in response to the user selecting button 514 or the “Accept Selected Jobs” button (e.g., via the user computing entity 10), the organizing system 100 may add the associated (sub-)job/task to the user's active job/task list or jobs/tasks pending approval list, as appropriate for the particular (sub-)job/task. In various embodiments, after a user has signed up for a (sub-)job/task, the available jobs/tasks page 515 or sub-jobs/tasks info page 517 may be updated to show the names of other users who have signed up for that (sub-)job/task. In some embodiments, after a user has signed up for a job/task, the available jobs/tasks page 515 or sub-jobs/tasks info page 517 may be updated by the organizing system 100 to display the names of users who have signed up for all of the available (sub-)jobs/tasks. In some embodiments, a user (e.g. operating a user computing entity 10 (e.g., 10A, 10B, 10C)) may be able to view the names of other users who have signed up for (sub-)jobs/tasks before the user signs up for a (sub-)job/task. In yet other embodiments, the names of other users who have signed up for (sub-)jobs/tasks are not provided to the user.

In various embodiments, the organizing system 100 may provide a my jobs/tasks page that may be displayed to the user (e.g., via the user computing entity 10). For example, the user may select my jobs/tasks sub-tab or select the active jobs/tasks link 564 associated with the job/task dashboard 560. The my jobs/tasks sub-tab may display a list of (sub-)jobs/tasks pending approval (e.g., (sub-)jobs/tasks the user has signed up for that are pending approval from a user having a user profile associated with appropriate administrative roles and/or privileges), active (sub-)jobs/tasks (e.g., (sub-)jobs/tasks the user has signed up for that have not yet been completed), and completed (sub-)jobs/tasks (e.g., (sub-)jobs/tasks the user has signed up for and have been at least partially completed). In various embodiments, a (sub-)job/task listed in the active job/task list may be moved to the completed job/task list when the time range and/or date associated with the active job/task has passed or when the user reports the hours worked in relation to at least partially completing the active job/task. The pending job/task, active job/task, and/or completed job/task list may include information related to each job/task such as where the job/task is to be completed (e.g., in the fifth grade class room, in the gym, at the PTA Festival, and/or the like), when the job/task is to be completed (e.g., a date, date range, time range, and/or the like), the work value assigned to the job/task or the work value assigned per hour to the job/task, a job/task status, expected or actual number of hours (e.g., up to 40 hours, 2 hours, 3.5 hours, and/or the like), users who have already signed up for a job/task, who approval is pending from or who approved a user to sign up for a position, who approved the creation of a job/task, and/or the like. In various embodiments, some jobs/tasks may be associated with a job/task specific forum provided by the organizing system 100 that is only accessible to users signed up for that job/task (and possibly users with appropriate administrative roles and/or privileges) (e.g., operating a user computing entity 10 (e.g., 10A, 10B, 10C)). For example, a job/task specific forum may be accessible via a link on the my jobs/tasks page. The my jobs/tasks page may also include links to more information related to a job/task. In various embodiments, the my jobs/tasks page may include a link to report hours worked in relation to at least the partial completion of the job/task. For example, a user (e.g., operating a user computing entity 10 (e.g., 10A, 10B, 10C)) may click on the line listing information related to a job/task to be provided by the organizing system 100 with a form for reporting hours worked in relation to at least the partial completion of a job/task.

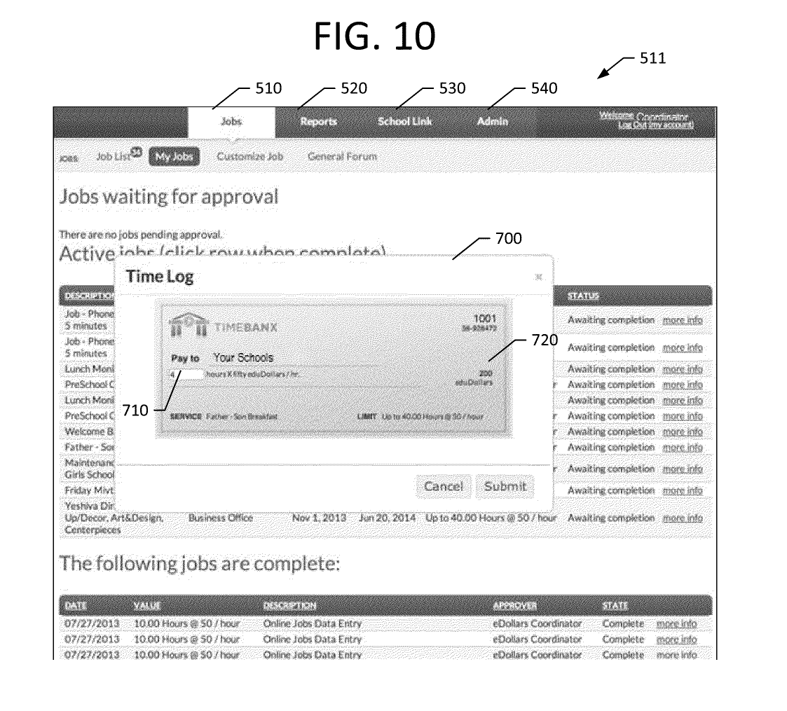

Returning to FIG. 3, at step 308, the organizing system 100 may receive hours worked by a user in relation to at least partial completion of a job/task. For example, FIG. 10 illustrates an example form that may be provided to a user (e.g., operating a user computing entity 10 (e.g., 10A, 10B, 10C)) upon indication that the user would like to report hours worked in relation to at least partial completion of a job/task. In the illustrated embodiment, the reporting form 700 is displayed over an example my jobs/tasks page 511. In various embodiments, the reporting form 700 provided by the organizing system 100 may include various information associated with the particular job/task for which the hours are being reported. For example, the illustrated reporting form 700 indicates that the particular job/task for which the hours are being reported is the Father-Son Breakfast and that the user can enter up to 40 hours of work related to the at least partial completion of the job/task. The reporting form 700 may also include the name of the organization for which the user was volunteering. Additionally, the reporting form 700 may include time entry field 710. The user may provide input (e.g., via the user computing entity 10) indicating the number of hours the user worked in relation to at least partially completing a job/task. In other embodiments, the user may select a number of hours worked from a list of options or otherwise select the number of hours worked in relation to at least partially completing the job/task. After a user has entered or selected the number of hours worked in relation to at least the partial completion of the job/task, the organizing system 100 may determine an achieved work value 720. For example, the job/task for which the hours are being entered for on reporting form 700 is assigned a work value of 50 eduDollars per hour. The user has entered that the user worked four hours in relation to the at least partial completion of the job/task. Therefore, in this example, the achieved work value is 200 eduDollars. Thus, as shown in FIG. 3, at step 310, the organizing system 100 determines the achieved work value. At step 312, the organizing system 100 stores the achieved work value in association with the user's profile, a family profile associated with the user, and/or the like. In various embodiments, the achieved work value is stored in association with the user profile in the user profile database 140.

As noted above, in various embodiments, a work value is assigned to a job/task. In various embodiments, the assigned work value may be a per hour value (e.g., 50 eduDollars per hour, one-eighth of a gift certificate per hour, 2 prize tickets per hour, one hour of work value for each hour worked, a real dollar amount per hour (e.g., in U.S. dollars), 10 points per hour, and/or the like). In various embodiments, the assigned work value may be based on the completion of the job/task (e.g., 200 eduDollars for completion of the job/task, a pizza party for the members of a graduation committee after the graduation, a free month of membership at a gym for members of a group who participate in group volunteer project, a gift certificate after completing 10 hours of work related to at least the partial completion of a job/task, a real dollar amount (in U.S. dollars or another currency) for completing a job/task, a student may get to participate in a class trip, activity, and/or the like upon completion by the student and/or associated users of a 100 hours, and/or the like). In the provided example embodiment, an eduDollar may be a virtual currency that may be used to pay a debt to the school (e.g., pay part or all of a tuition fee, pay a lab fee, pay PTA dues, pay library late fees, and/or the like). The work value assigned to different jobs/tasks may vary based on a variety of factors. For example, working the cotton candy booth at the PTA festival may be assigned a work value of 50 eduDollars per hour, and a task that must be performed by a trained electrician may be assigned a work value of 500 eduDollars for completion of the task, even if the task only takes two hours to complete.

Returning to FIG. 3, at step 312, the organizing system 100 provides a comparison of the achieved work value associated with the user and/or the user's family and the user and/or family work value goal to the user (e.g., via the user computing entity 10). For example, if the user or the user's family has achieved 100 eduDollars worth of work value, and, for example, the user or family's work value goal is 500 eduDollars worth of work value, the user may be informed that the user or the user's family have achieved 20% of their goal. In some embodiments, the organizing system 100 may provide a visual representation of the comparison of the achieved and goal work values (e.g., via the user computing entity 10 (e.g., 10A, 10B, 10C)). For example, a pie chart or motivational thermometer illustrating the comparison may be displayed to the user.

In various embodiments, the organizing system 100 may be configured to provide the user with a variety of reports and/or reporting options. For example, the user may select the reports tab 520 illustrated in FIG. 5 to access reports relating to the user's achieved work value, work value goal, amount owed for the year, current outstanding balance, and/or the like. The reports tab 520 may also provide a mechanism for a user to provide and/or update a user's reporting preferences that may be stored by the organizing system 100 in association with the user's profile (e.g., in the user profile database 140). For example, a user may wish to receive an email monthly providing an update regarding the achieved work value associated with the user's user profile or the user's family profile and/or providing a comparison of the achieved work value and the work value goal for the user and/or the user's family. In one embodiment, one user profile associated with a family profile may be indicated as the point profile for the users associated with that family. In such an embodiment, all reports and/or communications/emails with the users having user profiles associated with the family profile may be addressed to the user associated with the point profile for that family. In various embodiments, the user may indicate whether they would like to be shown a visual representation of the comparison between the achieved and goal work values for the user or the user's family. Users with appropriate administrative roles and/or privileges may access (e.g., via the user computing entity 10) the reports tab 520 to view organizational, family, and individual achieved work value, work value goals, owed balances, and/or progress toward achieving work value goals for various users and/or update personal and/or organization reporting preferences and options.

In various embodiments, the organizing system 100 may also provide the user (e.g., operating a user computing entity 10 (e.g., 10A, 10B, 10C)) with administrative functions, such as editing the user profile associated with the user, creating a user profile, editing roles and/or privileges associated with a user profile, creating jobs/tasks, authorizing jobs/tasks, and/or the like. In various embodiments, different users may have access to different administrative functions, as defined by the roles and/or privileges associated with the user profile associated with the user. For example, a user may select (e.g., via the user computing entity 10) the admin tab 540 illustrated in FIG. 5 to access administrative functions. In various embodiments, a user may access the admin tab 540 to edit the information associated with the user's user profile. In various embodiments, a user having appropriate administrative roles and/or privileges associated with his or her user account may access the admin tab 540 to create or edit one or more jobs/tasks, authorize posting of one or more jobs/tasks, authorize a user signing up for a job/task requiring authorization, manage and/or update other users' user profiles, creating user profiles, and/or the like. In various embodiments, a user having appropriate administrative roles and/or privileges associated with his or her account may access the admin tab 540 in order to change the roles and/or privileges associated with their or another user's user profile.

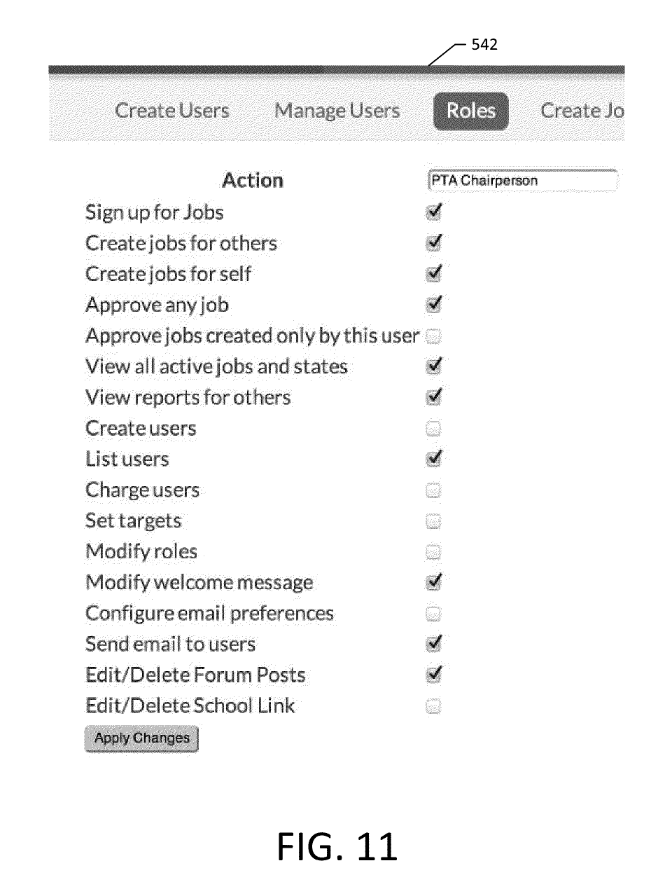

FIG. 11 shows an example partial screen shot of the roles sub-tab 542 under the admin tab 540. As illustrated, the possible roles or privileges that may be associated with a user profile include sign up for jobs/tasks, create jobs/tasks for others, create jobs for self, approve any job, approve jobs only created by this user, view all active jobs/tasks and states, view reports for others, create users, list users, charge users, set targets and/or work value goals, owed balances, modify user roles and/or privileges, modify welcome message on the welcome page 500, configure email preferences, send email to users, edit/delete forum posts, edit/delete school link, and/or the like. In various embodiments, a user having the appropriate roles and/or privileges associated with his or her user profile (e.g., the role of modifying user roles is associated with the user's user profile), may modify the roles and/or privileges associated with the user profile of any user at any time. In other embodiments, a user having the appropriate roles and/or privileges associated with his or her user profile (e.g., the role of modifying user roles is associated with the user's user profile), may modify the roles and/or privileges associated with the user profile of any user (perhaps other than the user profile associated with the program coordinator and/or site administrator) at any time.

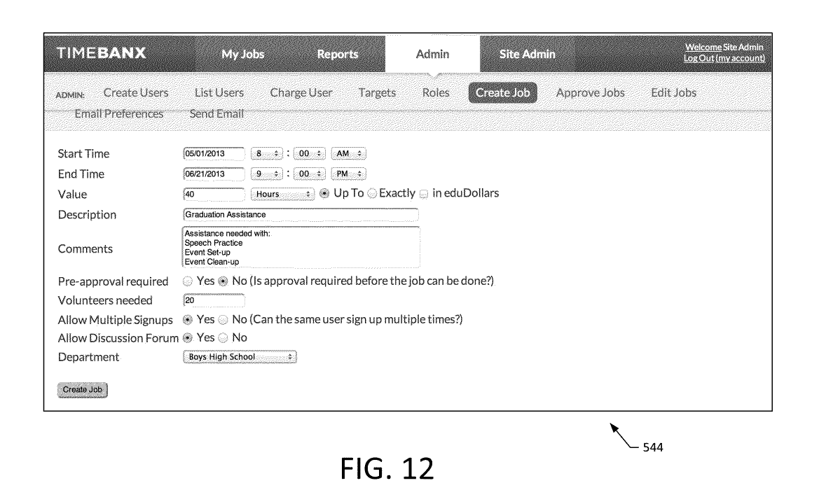

In various embodiments, a user with appropriate administrative roles and/or privileges associated with his or her user profile may create one or more jobs/tasks. For example, the user may access the create job/task sub-tab 544 under the admin tab 540. FIG. 12 illustrates an example create job/task sub-tab 544. The user may also indicate a work value that may be achieved by a user assisting to at least partially complete the job/task. For example, a particular job/task may allow the user assisting to at least partially complete the job/task up to 12 hours or exactly 12 hours worth of achieved work value. The user may also indicate how the work value will be measured. For example, the user may indicate that the work value will be measured in hours, eduDollars, eduDollars per hour, and/or the like. The user may also provide start date and time, end date and time, comments about, a description of, and/or a link to information regarding the job/task being created, indicate whether a job/task requires pre-approval before the job/task may be undertaken, how many volunteers and/or users are needed to complete the job/task or may be permitted to sign up for the job/task, whether multiple users are allowed to sign up for the job/task, if a job/task-specific discussion forum is to be set up, a department associated with the job/task (e.g., history department, middle school, boys' high school, girl's elementary school, preschool, athletic department, and/or the like).

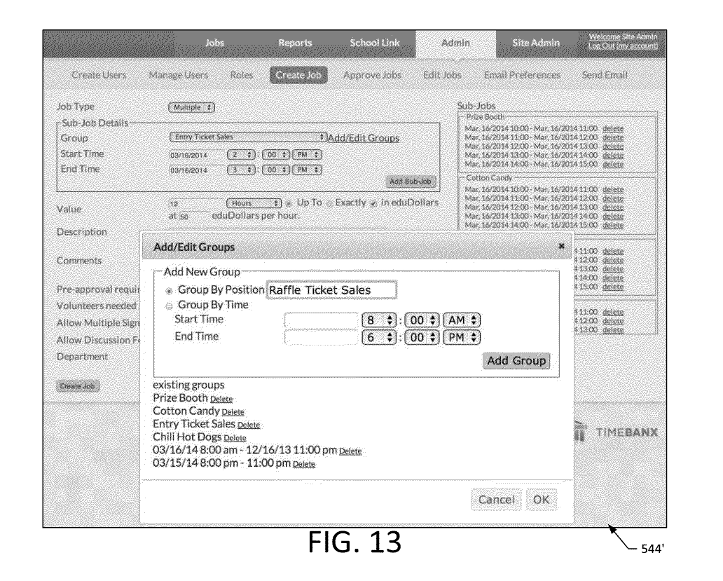

FIG. 13 illustrates another example of a create job/task sub-tab 544′, via which the user may indicate a job/task type such as a job/task having multiple parts/dates/time slots, a single part/date/time slot, a job that must be completed in person, over the phone, over the Internet, or some combination of those, and/or the like. Various jobs/tasks may be broken into sub-jobs/tasks. For example, if a job/task type associated with a job/task is “multiple,” the job/task may have multiple sub-jobs/tasks/dates/time slots associated therewith. Sub-jobs/tasks may be grouped according to various attributes related to the sub-job/task. For example, if the job/task is Volunteering at the PTA Festival, sub-jobs/tasks may include operating the cotton candy booth, selling raffle tickets, selling admission tickets, and/or the like. Several dates/time slots may be provided for which a user may select to volunteer to operate the cotton candy booth. Each of these dates/time slots may be grouped together under the group titled Cotton Candy Booth. Similarly, sub-jobs/tasks may be grouped by time range, date, number of volunteers needed, number of volunteer slots remaining, and/or another attribute of the sub-job/task. The groups and/or various attributes associated with each sub-job/task may be used to organize the sub-jobs/tasks listed on the available jobs/tasks page 515. The create jobs/tasks sub-tab 544′ may also list the sub-jobs/tasks/dates/time slots previously created for the particular job/task.

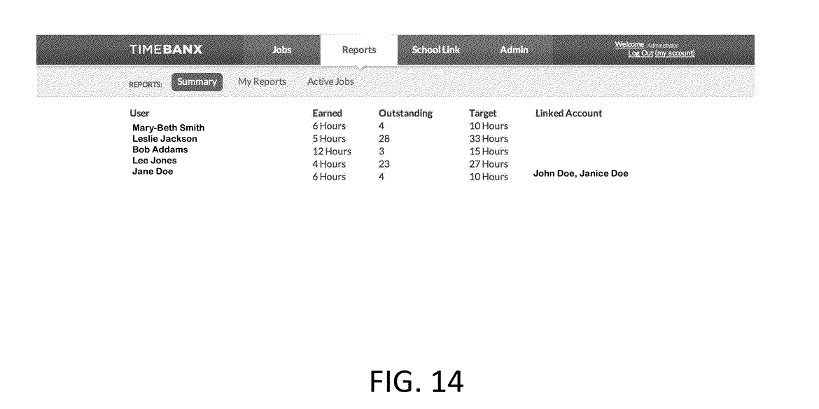

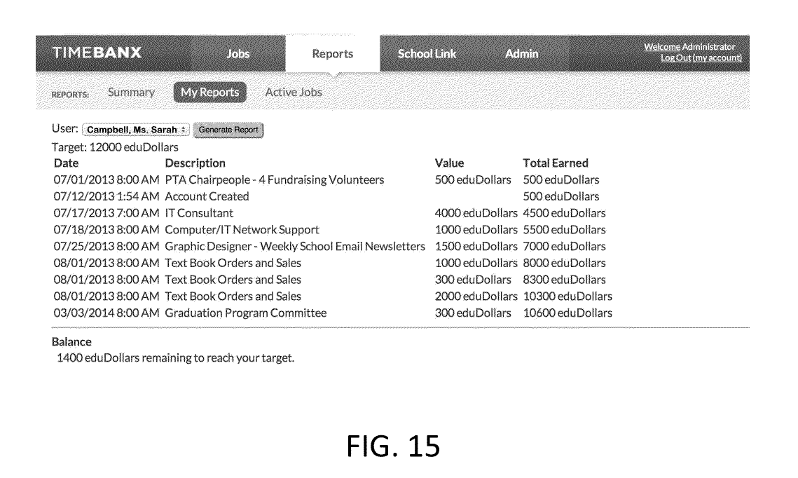

As illustrated in FIGS. 11 and 12, the admin tab 540 may also be associated with a variety of other sub-tabs (e.g., a create users sub-tab, a manage users sub-tab, an approve jobs/tasks sub-tab, an edit jobs/tasks sub-tab, an email preferences sub-tab, a send email sub-tab, a reports sub-tab, and/or the like). Depending on the roles and/or privileges associated with a user's user profile, various sub-tabs may or may not be present and/or accessible when the user (e.g., operating a user computing entity 10 (e.g., 10A, 10B, 10C)) accesses the admin tab 540. For example, if a user has appropriate roles and/or privileges associated with his or her user profile, the user (e.g., operating a user computing entity 10 (e.g., 10A, 10B, 10C)) may access the create users sub-tab and create one or more new user profiles. This function may be particularly useful in embodiments in which new users are assigned a user profile. For example, in one embodiment, each parent for each child newly enrolling in the school may be assigned a user profile, rather than each parent needing to create their own user profile. If a user has appropriate roles and/or privileges associated with his or her user profile, the user may access the manage users sub-tab to access a database of user profiles to edit, delete, and/or perform other functions with respect to one or more user profiles. For example, a user with appropriate roles and/or privileges associated with his or her user profile may edit user profile information for another user, manually credit a user profile with achieved work value (e.g., points, eduDollars, and/or the the like), adjust various user and/or family work value goals, and/or the like. Whether or not a user's profile is associated with the appropriate roles and/or privileges to modify other users' user profiles, the user may access an edit profile sub-tab or the like in place of or in addition to a manage users sub-tab. Accessing the edit profile sub-tab may provide the user with an opportunity to edit various information stored in association with the user's user profile (e.g., in the user profile database 140). For example, the user may be able to update the telephone number or address associated with the user's user profile. A user (e.g., operating a user computing entity 10 (e.g., 10A, 10B, 10C)) having the appropriate roles and/or privileges associated with his or her user profile may access the approve jobs/tasks sub-tab to approve one or more jobs/tasks that were previously created by another user whose user profile is associated with the role and/or privilege of being able to create a job/task, but is not associated with the role and/or privilege of being able to approve and/or post a job/task. A user with appropriate roles and/or privileges associated with his or her user profile may also access the approve jobs/tasks sub-tab to approve a user for completing the job/task, view a list of users signed up for a particular job/task, and /or the like. For example, as mentioned above, if a job/task requires a licensed electrician, a user having the appropriate roles and/or privileges may need to approve that the user(s) who signed up to assist with completion of the job/task is a licensed electrician. A user (e.g., operating a user computing entity 10) having the appropriate roles and/or privileges associated with his or her user profile may access the edit jobs/tasks sub-tab to edit one or more jobs/tasks that have been previously created and/or approved. For example, the user may edit the time, date, description, or other attributes associated with the job/task. Various reports may be viewed by a user associated with a user profile having the appropriate roles and/or privileges. FIG. 14 illustrates one example report in which a list of users are provided along with the work value achieved by each user, the work value owed by the user to reach the user's goal, and the work value goal for the user. FIG. 15 illustrates another example report for a particular user. The illustrated report lists information related to jobs/tasks the user assisted with at least the partial completion of, the earned work value earned for each jobs/tasks the user assisted with at least the partial completion of, and a running total to the user's achieved work value. The report may also list user's work value goal and the balance between the user's achieved work value and the user's work value goal. A similar report may be provided for a family profile.

A user having the appropriate roles and/or privileges associated with his or her user profile may access the email preferences sub-tab to edit one or more preferences related to emails associated with the parent volunteer program. For example, the formatting of emails sent by the parent volunteer program, the email address from which the emails are sent, and/or the like may be edited under the email preference sub-tab. Whether or not a user's user profile is associated with the appropriate roles and/or privileges for accessing the email preferences sub-tab, the user may be able to access a personal email preferences sub-tab. Via the personal email preferences sub-tab, the user (e.g., operating a user computing entity 10 (e.g., 10A, 10B, 10C)) may provide his or her preferences for receiving email. For example, some users may prefer to receive email in plain text while others prefer emails formatted via HyperText Markup Language (HTML). Users having a low bandwidth Internet connection at home may request minimized emails that do not include large graphics, attachments, and/or the like. In various embodiments, the personal email preferences sub-tab may be incorporated into the edit profile sub-tab and/or the like.

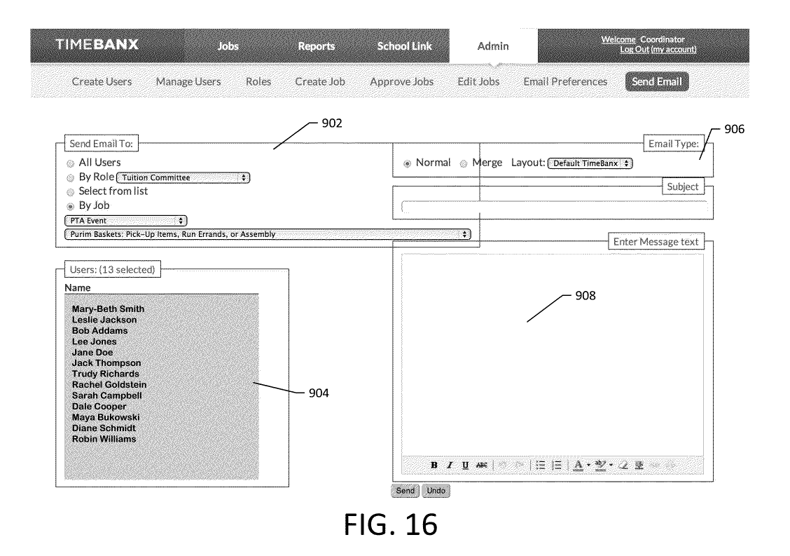

In various embodiments, a user having the appropriate roles and/or privileges associated his or her profile may send emails to users associated with user profiles associated with the parent volunteer program. FIG. 16 provides an example view of the send email sub-tab in one embodiment of the present invention. The email to selector 902 allows the user to select the users who will receive the email. For example, a user may wish to email other users based on roles associated with the user profiles, (sub-)jobs/tasks associated with the user profile, a custom selection of users, users associated with or who volunteer in a particular department, the chair people of one, multiple or all committees, to members of particular committee or sub-committee, all users associated with the parent volunteer program, and/or the like. The intended recipient list 904 shows the names of the users selected via the email to selector 902. The format selector 906 may provide the user sending the emails with a variety of email formatting options.

For example, an official school email template, a normal/plain email format, a parent volunteer program email format, a mail-merged format, and/or the like may be selected via the format selector 906. The user may then type the subject and body of the email into the email content section 908. When the user has finished preparing the email, the user may select (e.g., via the user computing entity 10 (e.g., 10A, 10B, 10C)), the send button. In various embodiments, the organizing system 100 may be configured to send automatic emails or other communications (e.g., text messages, alerts, notifications, voicemails, instant messages, and/or the like). For example, the organizing system 100 may be configured to send an email to a user 48, 24, 4, 2, or 1 hours before the start time of a job/task associated with the user profile associated with the user. Various other automatic communications may be facilitated by the organizing system 100 as appropriate for the application.

If a user has the appropriate roles and/or privileges associated with his or her user profile, the user (e.g., operating a user computing entity 10 (e.g., 10A, 10B, 10C)) may access the send email sub-tab to send an email (e.g., via the organizing system 100) to all of the users having user profiles associated with the parent volunteer program and/or a subgroup of the users having user profiles associated with the parent volunteer program. For example, a user having the appropriate roles and/or privileges may access the send email sub-tab and send an email to all users associated with a student in the Fifth grade, all users having user profiles associated with a particular skill set (e.g., sewing, woodworking, plumbing, electrical work, basketball, and/or the like), all users having a particular role or set of roles, all users signed up to assist with at least the partial completion of a (sub-)job/task, a particular profile assigned as the point person for a family, and/or the like. In some embodiments, emails may be automatically sent to all of the users having user profiles associated with the parent volunteer program and/or a subgroup of the users having user profiles associated with the parent volunteer program. For example, a user may receive a communication (e.g., email, text message, notification, voicemail, calendar reminder, and/or the like) 48 hours before a start time of a (sub-)job/task the user signed up for. As should be understood, a variety of administrative functions may be provided to users having the appropriate roles and/or privileges associated with their user profile. Additionally, it should be understood, that in various embodiments, various administrative functions may be organized in various fashions other than as sub-tabs as described herein.

In various embodiments, the organizing system 100 may provide other tabs (e.g., via a user computing entity 10 (e.g., 10A, 10B, 10C)). For example, as shown in FIGS. 5 and 6, a school link tab 530 may be provided. Or as shown in FIG. 12, a site admin tab may be provided. A school links tab (e.g., 530) may provide access to links associated with the school, various departments associated with the school, links that may be helpful for completing various jobs/tasks, and/or the like. A site admin tab may be provided such that a user having the appropriate roles and/or privileges associated with his or her user profile (e.g., the program coordinator and/or site administrator) may update, modify, and/or otherwise provide administrative functions for the parent volunteer program and the site itself. For example, the site admin tab may allow the program coordinator and/or site administrator to revert the site back to a previous version of the site. For example, the program coordinator and/or site administrator may revert the site back to how the site was at 10:00 am this morning or at 2:30 pm yesterday afternoon. For example, the program coordinator and/or site administrator (e.g., operating a user computing entity 10), may revert the site back to a previous version of the site stored in memory associated with the organizing system 100. Such an administrative function may be useful if the parent volunteer program site is hacked or if a well-meaning user accidently deletes something or modifies something inappropriately.

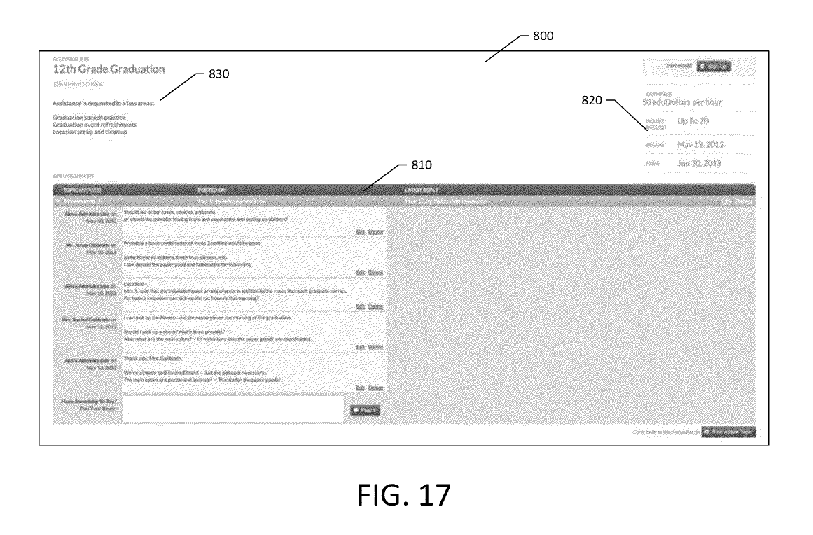

As noted above, a when a (sub-)job/task is created, the user creating the (sub-) job/task may indicate that a private discussion forum should be established for users signed up to assist with at least partially completing the job/task. For example, FIG. 17 shows a private discussion forum page 800 (e.g., provided by the organizing system 100) for users signed up to help organize the 12^{th} grade graduation. In the illustrated embodiment, the private discussion forum page 800 includes a discussion section 810, a job/task information section 820, and an updates area 830. In various embodiments, the discussion section 810 may function as a communication tool, message board and/or the like for users (e.g., operating a user computing entity 10 (e.g., 10A, 10B, 10C)) to exchange messages related to the job/task. The job/task information section 820 may list dates, times, potential achieved work value associated with the job/task, and/or other information related to the job/task. The updates area 830 may include information provided by a user (e.g., operating a user computing entity 10) having a user profile associated with the appropriate roles and/or privileges to update the private discussion forum page 800. In various embodiments, the updates section 830 may provide information about sub-jobs/tasks that are pending, sub-jobs/tasks that assistance is needed with, sub-jobs/tasks that are currently being worked on, sub-jobs/tasks that have been completed, and/or the like. For example, a private discussion forum page 800 may be edited (e.g., by select moderators) via the edit jobs/tasks sub-tab, and/or the like. In various embodiments, users associated with the job/task may receive a communication (e.g., notification, alert, email, text message, instant message, voicemail, and/or the like) when the discussion forum page 800 is updated, when a new message or communication is posted in the discussion section 810, and/or the like. Users signed up to help complete the job/task may access the private discussion forum page 800 to help facilitate at least the partial completion of the job/task.

In various embodiments, the organizing system 100 may provide a discussion forum for all users (e.g., operating a user computing entity 10) of the parent volunteer program and/or for sub-groups of users of the parent volunteer program. In various embodiments, such forums may be similar to the private discussion forum page 800 described above. For example, a discussion forum may be provided for all users associated with a seventh grader, all users associated with a student who plays basketball or plays in the school band, all users who are members of the PTA, and/or the like. It should be understood that a variety of other features may be incorporated into a parent volunteer program without departing from the spirit of the present invention.

### V. ALTERNATIVE EMBODIMENTS

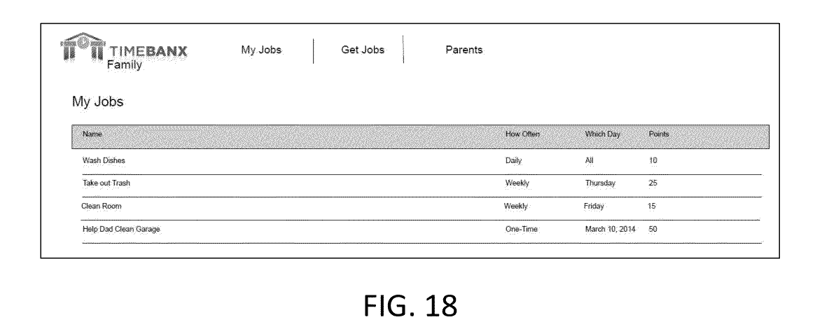

As noted above, the example provided above herein is a parent volunteer program associated with a school; however, various embodiments of the present invention may be incorporated into a variety of other programs configured to facilitate volunteer opportunities, customer loyalty programs (e.g., associated with a retailer, gym, non-profit, not-for-profit, and/or the like), achievement programs, child allowance programs, recreational or competitive teams, combinations thereof and/or the like. For example, FIG. 18 provides an example screen shot of an embodiment of the invention in which a family may use the concepts of organizing and facilitating completion of a task as described herein to track children helping out around the house and/or community. For example, an organizing system (e.g., organizing system 100) may provide a user interface accessible via a user computing entity (e.g., user computing entity 10A, 10B, 10C) via which a child may be assigned or choose the jobs/tasks of washing the dishes daily, taking out the garbage once a week, cleaning his or her room once a week, and helping Dad with the spring garage clean out. In exchange for completing these tasks, the organizing system (e.g., organizing system 100) may award the child points or some other achieved work value. For example, the child's parents may take the child out for a special treat every time the child earns 100 points. Or the child may earn $20 every time the child earns 200 points and/or the like.

In yet another example embodiment, a student work and/or volunteer program may be provided. For example, the user may be a student and a member of a class. The student may volunteer to complete various jobs/tasks at the school or participate in various school/class sponsored or approved volunteer opportunities. For example, a high school student may participate in a program in which once a week during lunch time or after school the student mentors and/or tutors an elementary school student. Or the student may volunteer to help out with administrative tasks at the school during their study hall period. In other examples, the student may volunteer at a nursing home, with the local government, at a children's hospital, at a community garden, with a boy/girl scout troop, and/or the like. For completing various student jobs, volunteering and/or completing other jobs/tasks, the student may earn various rewards, motivational points, get to participate in special class activities (e.g., a class trip, a pizza party, and/or the like), receive motivational points, and/or the like. The hours worked, volunteered and/or jobs/tasks completed by members of the class may also be tracked toward completion of a class goal. For example, if a class meets a class goal based on the earned work value of members of the class, the class may get to participate in a special class trip, a class party, or be provided with some other reward or motivation.

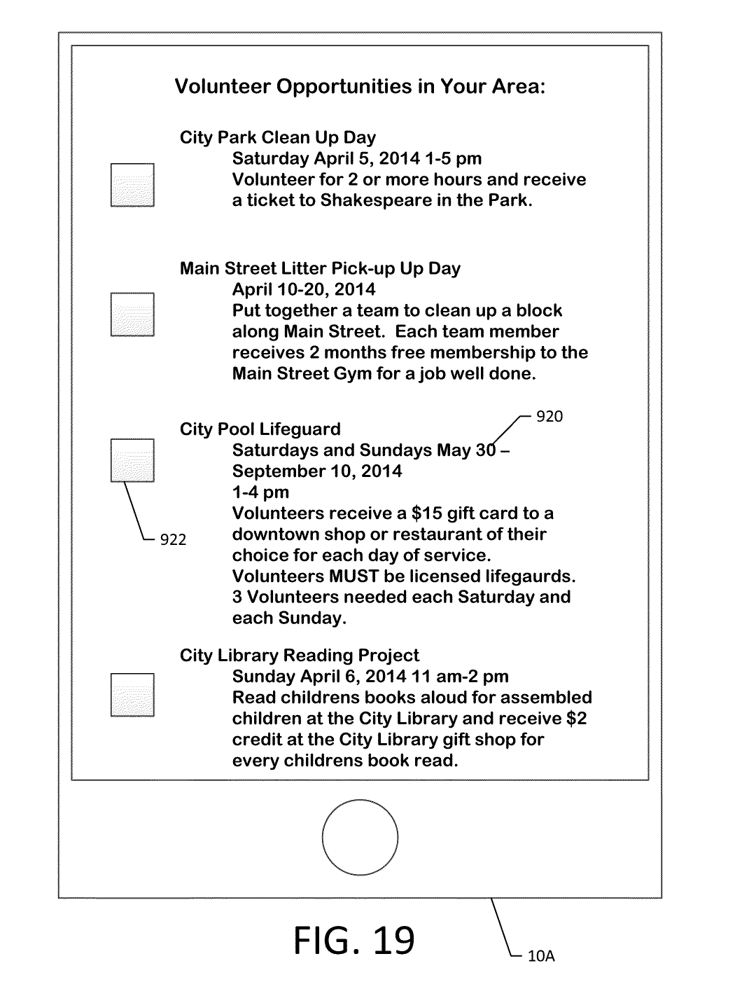

In a further embodiment, an impromptu group may be organized and/or facilitated to complete one or more jobs/tasks. For example, a group organized by a location (e.g., city, zip code, school district, neighborhood, and/or the like), interest, hobby, and/or the like, may receive communications and/or information regarding a volunteer opportunity. In one example, users in a particular zip code may be provided an opportunity to create teams to complete various jobs/tasks and/or achieve various goals (picking up litter in various parts of the zip code, cleaning and/or beautifying a portion of a local park, and/or the like). The volunteer opportunity may be associated with motivational group, team, and/or individual goals. For example, if a group, team, and/or individual goal is met, the group, team, and/or individual may be provided with two months of free gym membership, a retail gift card, a free city parking voucher for a week, a gift card or coupon for food, ice cream, or beverage establishments, and/or the like. FIG. 19 provides an example screen shot view of a mobile application for communicating about, organizing, and facilitating completion of jobs/tasks (e.g., operating on user computing entity 10A). Descriptions of various volunteer opportunities 920 may be provided with date, time, and information regarding the associated potential work value. To sign up for a job/task and/or to receive more information regarding the job/task, the user may select box 922. Various other features may be provided via the mobile application (e.g., operating on user computing entity 10A) as described above.

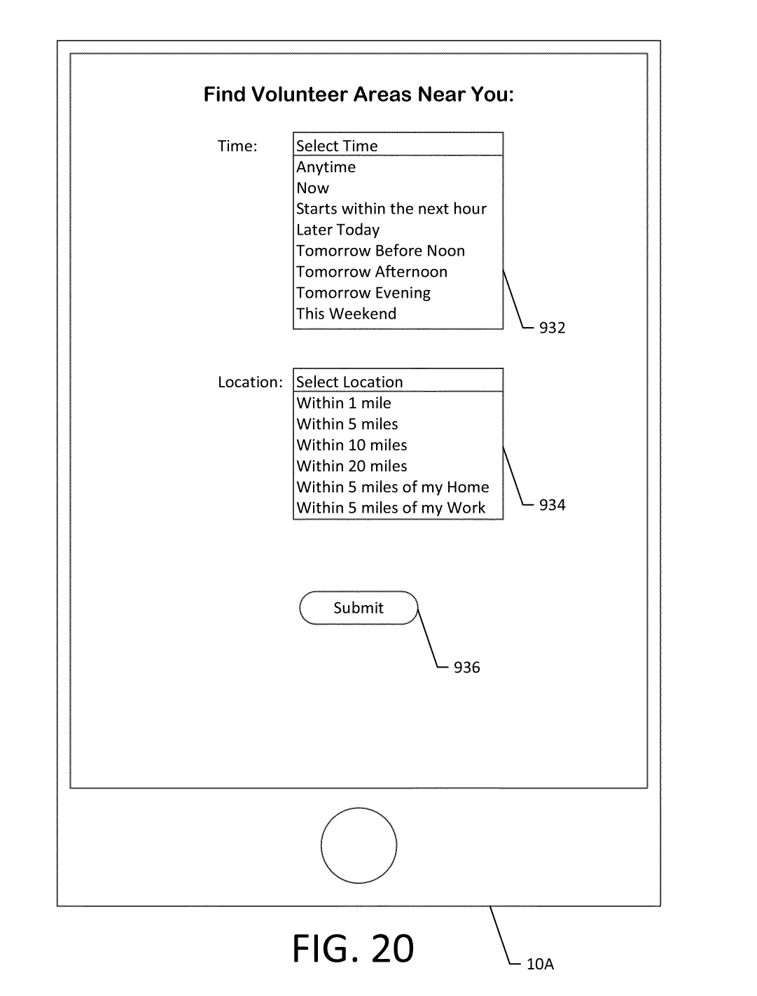

In another embodiment, a user may be able to search (e.g., via a user computing entity 10 (e.g., 10A, 10B, 10C)) for available jobs/tasks based on a location and/or time associated with the jobs/tasks. For example, as shown in FIG. 20, a user may select a provided time option from a list of time options 932 displayed on the user computing entity 10A and/or select a provided location option from a list of location options 934 displayed on the user computing entity 10A. For example, a user may be interested in a volunteer opportunity occurring now and within walking distance of the user's current location. Therefore, the user may select “now” from the list of time options 932 and “within 1 mile” from the list of location options 934. In various embodiments, a user may have previously provided one or more addresses and/or locations associated with the user that may be stored in association with the user profile. For example, a user may provide (e.g., via a user computing entity 10 (e.g., 10A, 10B, 10C)) a home address, a work address, the address of a favorite brunch establishment, and/or the like. In such embodiments, a user may be provided with the option to search volunteer opportunities within a particular distance of one of the provided addresses (e.g., within 5 miles of my work). In other embodiments a user may provide an address and a radius within which the user would like to search for volunteer opportunities and/or the user may provide a time (e.g., 5-6 pm on Tuesday Apr. 1, 2014). After selecting and/or providing a time and/or location query, the user select the submit button 936 (e.g., via the user computing entity 10A) to be provided with search results. The search results may be provided in a manner similar to that shown in FIG. 19 or as appropriate for the application.

### VI. CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for communicating about, organizing, and facilitating completion of tasks, the system comprising one or more memory storage areas and one or more processors, the system configured to:
store information associated with one or more tasks to be completed, the information comprising a work value associated with each of the one or more tasks;
store information associated with a plurality of user profiles, wherein (a) each user profile is associated with a user and (b) at least a first user profile and a second user profile are linked to create a group profile;
receive input associated with the first user profile and indicating hours worked by a user associated with the first user profile to assist with completion of one of the one or more tasks;
associate a work value with the received input based at least in part on at least one of the work value associated with the one of the one or more tasks and the hours worked by the user to assist with completion of the one of the one or more tasks; and
store said work value in association with the first user profile and the group profile.

2. The system of claim 1, further configured to:
receive input associated with at least one of one or more of the plurality of user profiles, one or more of the plurality of user profiles associated with one of the one or more tasks, a time frame, a relative time frame, wherein the relative time frame is defined relative to a time associated with one of the one or more tasks; and
transmit an electronic communication in accordance with the received input.

3. The system of claim 1, wherein a group goal value is associated with said group profile.

4. The system of claim 3, wherein the system is further configured to provide information comparing said work value and said group goal value associated with said group profile.

5. The system of claim 1, wherein the system is further configured to receive a request to assign the first user profile to the one of the one or more tasks.

6. The system of claim 1, wherein the information associated with the task to be completed comprises: at least one date, at least one of a time or a time range, and at least one of a task title or a task description.

7. The system of claim 1, wherein the work value is at least one of a virtual dollar amount per hour, a virtual dollar amount, a point value, a point value per hour, a number of prize tickets, a number of prize tickets per hour, a reward, a level, a badge, or a step toward receipt of a reward.

8. The system of claim 1, wherein the system is further configured to provide access to a task forum that is only accessible via a user profile associated with input indicating that the user associated with the user profile would like to assist with completion of the task.

9. The system of claim 1 further configured to:
receive information associated with a first user profile comprising information associated with a custom task;
store the information associated with the custom task; and
assign the first user profile to the custom task.

10. A method for communicating about, organizing, and facilitating completion of tasks comprising:
storing information associated with one or more tasks to be completed, the information comprising a work value associated with each of the one or more tasks;
storing information associated with a plurality of user profiles, wherein (a) each user profile is associated with a user and (b) at least a first user profile and a second user profile are linked to create a group profile;
receiving input associated with the first user profile and indicating hours worked by a user associated with the first user profile to assist with completion of one of the one or more tasks;
associating a work value with the received input based at least in part on at least one of the work value associated with the one of the one or more tasks and the hours worked by the user to assist with completion of the one of the one or more tasks; and
storing said work value in association with the first user profile and the group profile.

11. The method of claim 10, further comprising:
receiving input associated with at least one of one or more of the plurality of user profiles, one or more of the plurality of user profiles associated with one of the one or more tasks, a time frame, a relative time frame, wherein the relative time frame is defined relative to a time associated with one of the one or more tasks; and
transmitting an electronic communication in accordance with the received input.

12. The method of claim 10, wherein a group goal value is associated with said group profile.

13. The method of claim 12, further comprising providing information comparing said work value and said group goal value associated with said group profile.

14. The method of claim 10, further comprising receiving a request to assign the first user profile to the one of the one or more tasks.

15. The method of claim 10, wherein the information associated with the task to be completed comprises: at least one date, at least one of a time or a time range, and at least one of a task title or a task description.

16. The method of claim 10, wherein the work value is at least one of a virtual dollar amount per hour, a virtual dollar amount, a point value, a point value per hour, a number of prize tickets, a number of prize tickets per hour, a reward, a level, a badge, or a step toward receipt of a reward.

17. The method of claim 10, further comprising providing access to a task forum that is only accessible via a user profile associated with input indicating that the user associated with the user profile would like to assist with completion of the task.

18. The method of claim 10 further comprising:
receiving information associated with a first user profile comprising information associated with a custom task;
storing the information associated with the custom task; and
assigning the first user profile to the custom task.

19. A computer program product for communicating about, organizing, and facilitating completion of tasks, the computer program product comprising at least one non-transitory computer-readable storage medium having computer-readable program code portions stored therein, the computer-readable program code portions comprising:
an executable portion configured for receiving a plurality of data, the plurality of data comprising:
information associated with one or more tasks to be completed, the information comprising a work value associated with each of the one or more tasks, and
information associated with a plurality of user profiles, wherein (a) each user profile is associated with a user and (b) at least a first user profile and a second user profile are linked to create a group profile; and
an executable portion configured to receive input associated with the first user profile and indicating hours worked by a user associated with the first user profile to assist with completion of one of the one or more tasks;
an executable portion configured to associate a work value with the received input based at least in part on at least one of the work value associated with the one of the one or more tasks and the hours worked by the user to assist with completion of the one of the one or more tasks; and
an executable portion configured to store said work value in association with the first user profile and the group profile.

20. The computer program product of claim 18, wherein a family goal value is associated with said family profile; and
the computer-readable program code portions further comprise:
an executable portion configured to provide a comparison of said work value and said family goal value associated with said family profile.

21. The computer program product of claim 17, wherein the computer-readable program code portions further comprise an executable portion configured to receive a request to assign the first user profile to the one of the one or more tasks.
